(19) United States
(12) Patent Application Publication
(10) Pub. No.: US 2007/0245974 A1
(43) Pub. Date: Oct. 25, 2007

(54) Multifunction open-air incubator

(76) Inventor: Yi-Chin Chen, South EI Monte, CA (US)

Correspondence Address: CHARLES E. BAXLEY, ESQ., 90 JOHN STREET, THIRD FLOOR, NEW YORK, NY, 10038, US

(21) Appl. No.: 11/410,462

(22) Filed: Apr. 25, 2006

(51) Int. Cl. A01K 41/00; A01K 41/02

(52) U.S. Cl. 119/311; 119/312

(57) ABSTRACT

The present invention provides a multifunction open-air incubator, which typically includes a box made of insulation material, wherein the low portion is formed a sealed incubator with a chamber located between said incubator and the box shell; on the top side of the box, a kitchen sink is located, and the inlet and drain passing through the space between the incubator and the box shall are led out the box from the back side of the box to connect with the inlet pipe and drainage respectively. Due to integrating a kitchen sink and an incubator into the insulation box, in real using, the present invention saves a kitchen equipment space; meanwhile by means of putting ice cubes and ice pads into the kitchen sink and said chamber, said incubator can be cooled simultaneously.

### BACKGROUND OF THE INVENTION

1. Field of the Invention

The present invention relates to open-air kitchen equipment, and more particularly to a multifunction open-air incubator.

2. Description of Prior Art

In the western countries, people are used to taking picnic or holding a barbecue in the outdoor, so a variety of cooking for camping came out, such as charcoal barbecue, incubator, kitchen sink, and so on. Due to no station power supplied in open-air, most of said incubator adopt physical thermal insulation in principle, such as putting ice cubes and ice pads into the inside of container, and planting beverage bottle in for cooling; or using incubator insulating heat to preserve foods. So said incubators are manufactured to unitary whatever functions or styles. Therefore, providing multifunction kitchen equipment integrates several kitchen functions as a whole is the key object of the present invention.

### OBJECTS AND SUMMARY OF THE INVENTION

It is therefore a main object of the present invention to provide a multifunction open-air incubator integrated with a kitchen sink for meeting multiple purposes.

For achieving the above-mentioned object, the present invention provides a multifunction open-air incubator, which typically includes a box made of heat-insulation material, wherein, the low portion is formed a sealed incubator with a chamber located between said incubator and the box shell; on the top side of the box, a kitchen sink is located, and the inlet and drain passing through the space between the incubator and the box shall are led out the box from the back side of the box to connect with the inlet pipe and drainage respectively.

Said incubator has an openable door located on the front, and a temperature meter located on front surface of the door to indicate the temperature of the incubator.

Said incubator has a level shelf located at the inside to deviate the inside space into upper and low portions for preserving foods equitably.

Said box has a little movable door built on the rear plate.

Said kitchen sink is attached with a faucet on the top side.

Said box has two collapsible wing pallets respectively located on the both sides of the kitchen sink.

As utilizing above-mentioned project, due to integrating a kitchen sink and an incubator into the insulation box, in real using, the present invention saves a kitchen equipment space; meanwhile by means of putting ice cubes and ice pads into the kitchen sink, the incubator can be cooled, and said chamber also can be put into with ice cubes and ice pads for further cooling the temperature of the incubator, so that the incubator is kept into a lower temperature during a longer time; additionally, spreading up the two wing pallets beyond the kitchen sink offers two extended table surfaces for placing substances increasing the functions of the present invention.

### BRIEF DESCRIPTION OF THE DRAWINGS

FIG. 1 is a perspective view of the present invention.

FIG. 2 is a sectional perspective view showing the A-A section of FIG. 1.

FIG. 3 is a perspective view showing the open state of the present invention.

FIG. 4 is a back side perspective view of the present invention.

FIG. 5 is a cross-section view showing the B-B section of FIG. 4.

FIG. 6 is a perspective view showing another embodiment in state one of the present invention.

FIG. 7 is a perspective view showing another embodiment in state two of the present invention.

### DETAILED DESCRIPTION OF PREFERRED EMBODIMENTS

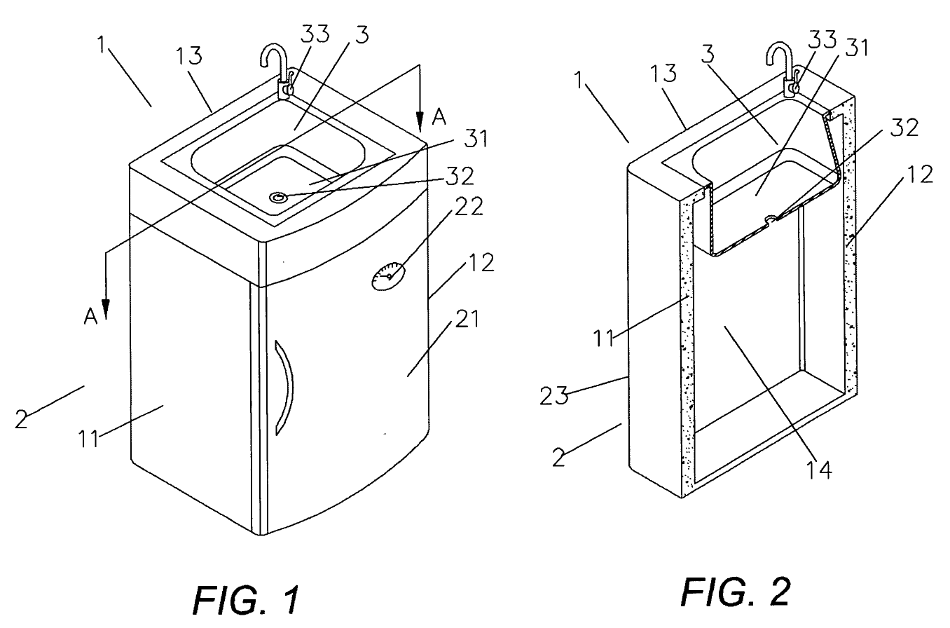

Referring to FIG. 1, a multifunction open-air incubator discovered by the present invention typically includes a box 1, an incubator 2 located on the low portion and a kitchen sink 3.

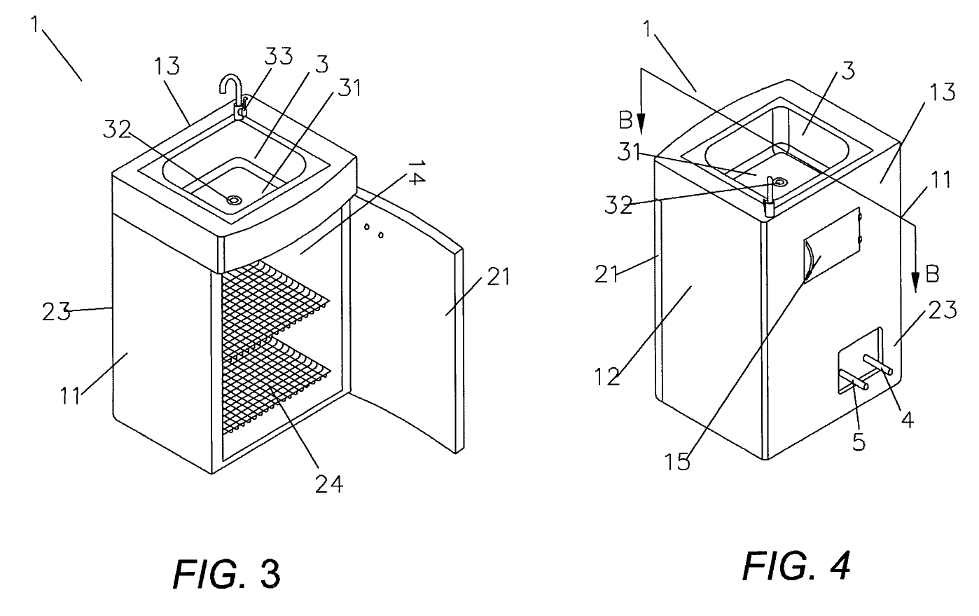

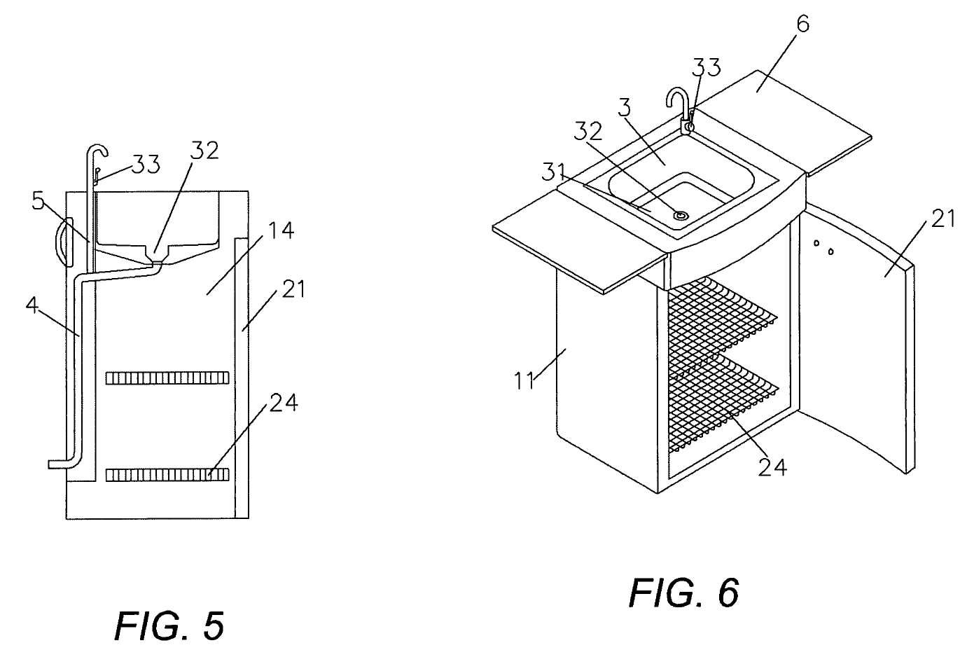

Referring to FIG. 2 to FIG. 5, said box is constructed all sides with good insulation material (such as PU foam, fiberglass reinforced plastics and so on), said box 1 has an incubator 2 located on the low portion with an openable door 21, and a temperature meter 22 located on the surface of the door 21, and tow side plates 11 12 structuring the side walls of said incubator 2, and a baffle plate 23 built on the back side of said incubator 2 as the back wall, and a level shelf 24 dividing said incubator 2 for preserving foods equitably, and a gap chamber 14 deviated from the space between the baffle plate 23 and the rear plate 13.

Said box 1 is integrated with a kitchen sink 3 on the top side, so that the bottom side 31 of the sink 3 becomes the top side of the incubator 2, said bottom side 31 of the kitchen sink 3 has a spout 32 built on the center connecting with a drain pipe 4, and a faucet 33 is set upon the top side of the kitchen sink 3 to connect to a inlet pipe 5 with the bottom inlet, said drain pipe 33 and said inlet pipe 5 are let out passing through the gap chamber 14 via the rear plate 13 to connect to the inlet pipe and drainage respectively.

Referring to FIG. 4, said box 1 has a movable little door 15 communication with the gap chamber 14 built upon the rear plate 13.

As using, the flowing water washing something in the kitchen sink 3 can further cool the incubator 2, by means of putting ice cubes and ice pads into the kitchen sink 3, the incubator 2 can be cooled, and said gap chamber 14 also can be put in with ice cubes and ice pads for further cooling the temperature of the incubator 2, so that the incubator is cooled via the back wall 23. Said temperature meter 22 located on the surface of the door 21 can indicate the inside temperature of the incubator 2 in time facilitating to use.

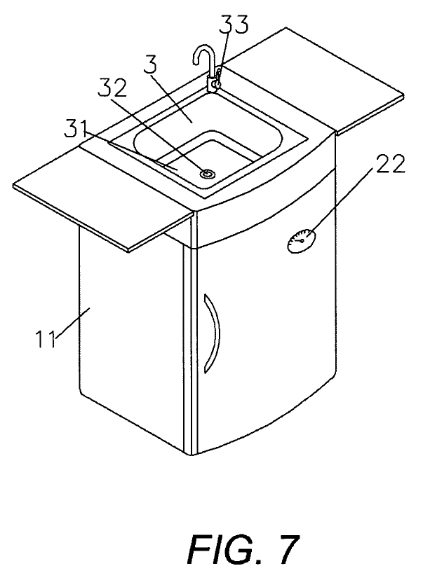

On the other hand, referring to FIG. 6 and FIG. 7, said box 1 has two collapsible wing pallets 6 respectively located on the both sides of the kitchen sink 3; in using spreading up the two wing pallets 6 beyond the kitchen sink 3 offers two extended table surfaces for placing substances, but in idle time, they can be folded down saving space.

In conclusion, the present invention integrates an incubator and a kitchen sink and tables into one whole body, not only facilitating to use, but also saving occupation space.

I claim:

1. A multifunction open-air incubator typically including a box made of insulation material, wherein the low portion is formed a sealed incubator with a chamber located between said incubator and the box shell; on the top side of the box, a kitchen sink is located, and the inlet and drain passing through the space between the incubator and the box shall are led out the box from the back side of the box to connect with the inlet pipe and drainage respectively.

2. A multifunction open-air incubator as claimed in claim 1, wherein said incubator has an openable door located on the front, and a temperature meter located on front surface of the door to indicate the temperature of the incubator.

3. A multifunction open-air incubator as claimed in claim 1, wherein said incubator has a level shelf located at the inside to deviate the inside space into upper and low portions for preserving foods equitably.

4. A multifunction open-air incubator as claimed in claim 1, wherein said box has a little movable door built on the rear plate.

5. A multifunction open-air incubator as claimed in claim 1, wherein said kitchen sink is attached with a faucet on the top side.

6. A multifunction open-air incubator as claimed in claim 1, wherein said box has two collapsible wing pallets respectively located on the both sides of the kitchen sink.
